(19) United States
(12) Patent Application Publication
(10) Pub. No.: US 2007/0065251 A1
(43) Pub. Date: Mar. 22, 2007

(54) Lockbolt and production method for joining at least two component layers

(75) Inventors: Juergen Otten, Tiste (DE); Matthias Otten, Tiste (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/533,613

(22) Filed: Sep. 20, 2006

Related U.S. Application Data
(60) Provisional application No. 60/718,937, filed on Sep. 20, 2005.

(30) Foreign Application Priority Data
Sep. 20, 2005 (DE) 10 2005 044 824.0

(51) Int. Cl. F16B 19/00

(52) U.S. Cl. 411/361

(57) ABSTRACT

The field relates to a lockbolt for joining at least two component layers. The field furthermore relates to a method for producing a lockbolt connection between at least two component layers, as well as to an aircraft in which at least two component layers are joined with the lockbolt. The lockbolt includes a bolt shaft with a bolt head, as well as a tear-off shaft that is connected to the bolt shaft at a predetermined breaking point. An elastic clamping element provided on the tear-off shaft serves to fix the lockbolt in a through-hole.

### REFERENCE TO RELATED APPLICATIONS

This application claims the benefit of the filing date of German Patent Application No. 10 2005 044 824.0 filed Sep. 20, 2005 and of U.S. Provisional Patent Application No. 60/718,937 filed Sep. 20, 2005, the disclosures of which are hereby incorporated herein by reference.

### FIELD OF THE INVENTION

The field relates to the technical field of manufacturing composites from several material layers. The field pertains to a lockbolt for joining at least two component layers. The field furthermore relates to a method for producing a lockbolt connection between at least two component layers, as well as an aircraft in which at least two component layers are joined with the lockbolt.

### BACKGROUND OF THE INVENTION

In the field of aircraft construction and, in particular, structural assembly, it is frequently required to connect two or more component layers to one another in a non-positive fashion in order to increase the rigidities of a structural component such as, for example, an aircraft fuselage or an airfoil. In this case, it is common practice to join the component layers with the aid of clinch bolts that are realized in the form of shear pins and referred to as lockbolts in the pertinent terminology, wherein these lockbolts may have a headed bolt shaft and a so-called tear-off shaft. Since the present application is intended for persons skilled in the art of joining technology, the term “lockbolt” is therefore also used in connection with clinch bolts of this type in the context of the field of the invention.

A conventional method for joining two component layers with the aid of a conventional lockbolt is described below with reference to FIG. 1. Illustration I of FIG. I shows two component layers 1, 2 that is connected to one another by a lockbolt 3, wherein both component layers 1, 2 are provided with a through-bore for this purpose. In a typical method, the lockbolt is at first loosely inserted into the through-hole as shown an Illustration I. The lockbolt 3 consists of a fitted bolt, i.e., the bolt shaft 5 is very precisely adapted to the diameter of the through hole such that the bolt shaft 5 may be completely inserted into the through-hole under the influence of a force. For this purpose, the lockbolt 3 is inserted into the through-hole in the above-described fashion such that its bolt shaft is seated in the inlet of the through-hole. In order to prevent the lockbolt from falling out of the through-hole again during the ensuing installation steps, it is provisionally fastened in the typical method with a slight stroke on the bolt head in the position shown in Illustration I such that the bolt shaft of the lockbolt 3 is slightly clamped in the through-hole.

The riveting process is then continued by drawing the lockbolt 3 completely into the through-hole from the bottom as shown in Illustration I with the aid of a drawing tool (not depicted) such as, for example, tongs. At this point, a lockbolt 3 may not be completely driven into the through-hole as shown an Illustration II because this may lead to deformations of the lockbolt 3 due to the very soft lockbolt materials and therefore render the lockbolt unusable.

As soon as the lockbolt is completely drawn in (Illustration III), a locking ring 7 is pushed on the tear-off shaft 6 and subsequently clamped on the bolt shaft 5 with the aid of a clamping tool (Illustrations IV-VI). Since the clamping of the locking ring 7 is frequently carried out in the form of overhead work, the locking ring 7 may need to be manually held on the tear-off shaft 6 with one hand such that it does not slide off again on its own before the clamping tool 9 is attached. Due to the heavy weight of the clamping tool 9, this type of installation may be ergonomically unfavorable and may lead to premature fatigue of the installer due to the fact that the clamping tool may only be held with one hand, and the user may have to use the other hand to hold the locking ring 7 on the tear-off shaft 6.

Illustrations IV and V show the completion of the installation in which the locking ring 7 is clamped on the bolt shaft 5 by retaining a first gripper (not depicted) of the clamping tool 9 on the tear-off shaft 6 and another second gripper (not depicted) pushing the locking ring 7 on the bolt shaft 5 (Illustration V). If the second gripper is additionally displaced in the direction of the bolt shaft 5, the lockbolt 3 may subjected to tensile stress such that the tear-off shaft 6 may ultimately torn off the bolt shaft 5 at a predetermined breaking point (Illustration VI).

The typical method described above may prove disadvantageous. For example, the lockbolt may already suffer damages due to the slight stroke on the bolt head in order to provisionally fasten the lockbolt in the through-hole, in which case the lockbolt may need to be exchanged. This provisional fastening stroke may also associated with the problem that lockbolts which were already provisionally fastened may be loosened again due to the provisional fastening stroke on an adjacent lockbolt head and may even fall out of the through-hole. In addition, these provisional fastening strokes may result in a significant noise level that unfavorably affects the work atmosphere. As mentioned above, the conventional method is also ergonomically unfavorable due to the fact that the installer may have only one hand available for operating the clamping tool because the other hand may need to hold the locking ring on the tear-off shaft.

### SUMMARY OF THE INVENTION

Among other things, it may be one object to reduce the risk of damaging the lockbolts and to achieve an ergonomic manufacturing method for connecting two component layers by a lockbolt. According to one example, the objective thereof is attained with a lockbolt that is specially adapted for joining at least two component layers that have a through-hole for accommodating the lockbolt. The lockbolt comprises a bolt head, on which a bolt shaft is conventionally arranged such that it protrudes from the bolt head. The lockbolt furthermore includes a tear-off shaft that extends from the bolt head in the form of an extension of the bolt shaft and is connected to the bolt shaft at a predetermined breaking point. The predetermined breaking point may be achieved in the form of a material weakening between the bolt shaft and the tear-off shaft in this case. In one example, a lockbolt of this type with an elastic clamping element on its tear-off shaft in order to temporarily fix the lockbolt in a through-hole, may be presented.

Due to the fact that the lockbolt may be fixed in the through-hole with the aid of a clamping element, it may no longer be necessary to provisionally fasten the lockbolt in the through-hole with a separate stroke as it is often the case with a conventional riviting method. The lockbolt is in fact pushed into the through-hole with its tear-off shaft and the clamping element arranged thereon and clamped in the through-hole by the clamping element such that a separate provisional fastening stroke may no longer be required. The risk of damaging the lockbolt with a separate provisional fastening stroke may be reduced with very simple means in this fashion. The elimination of a separate provisional fastening stroke also may allow the reduction of noise level during the lockbolt installation and therefore may improve the work atmosphere. In addition, lockbolts that are already inserted into a through-hole but not yet provisionally fastened no longer tend to become loose and possibly even fall out of the through-hole due to the no longer required provisional fastening strokes. Frequently, a separate provisional fastening strokes on another lockbolt is utilized by the conventional method.

Since the clamping element is adapted for clamping a lockbolt inserted into a through-hole in the through-hole, a separate provisional fastening stroke may be eliminated, because the lockbolt is already provisionally fastened in the through-hole due to the clamping effect achieved with the clamping element. Consequently, the lockbolt may allow the reduction of individual steps for producing a lockbolt connection, and results in a significant cost reduction in light of the thousands of lockbolts used in the structural assembly of an aircraft as described in greater detail below.

According to one embodiment, the bolt shaft thereof has a first diameter D and the tear-off shaft has a second diameter d in the region of the clamping element, wherein d<D applies. In order to ensure that the lockbolt may be easily inserted into the through-hole with its tear-off shaft, the second diameter d of the tear-off shaft is smaller than the diameter of the through-hole. The inserted lockbolt is prevented from simply falling back out of its through-hole by providing the tear-off shaft with the aforementioned clamping element, whose thickness is chosen such that the largest diametrical dimension Win the region of the clamping element and the tear-off shaft may be greater than or equal to the first diameter D of the bolt shaft. In this context, the term thickness of the clamping element refers to the radial dimension of the clamping element beginning at the outer circumference of the tear-off shaft. Furthermore, the diametrical dimension W refers to the maximum cross-sectional dimension through the clamping element and the tear-off shaft. The reason for the relation, according to which the diametrical dimension W is greater than or at least equal to the first diameter D, is that the first diameter D has exactly the size that makes it possible to insert the lockbolt into the through-hole in the form of a fitted bolt. Since the clamping element has elastic properties, the diametrical dimension consequently may be chosen at least as large as the first diameter D such that the lockbolt may be clamped in the through-hole by the clamping element.

In order to ensure that a clamped lockbolt may be completely drawn into the through-hole by utilizing a drawing tool, for example, tongs, as with conventional riveting methods, the clamping element is arranged on the tear-off shaft in such a way that the tear-off shaft protrudes from the component layers to be joined in the temporarily fixed position of the lockbolt. Due to these measures, the lockbolt may be easily taken hold of with a drawing tool on the side of the component layers to be joined that lies opposite of the bolt head and completely drawn into the through-hole.

In the position in which the lockbolt is completely drawn into the through-hole in this fashion, the tear-off was pulled out of the through-hole together with the clamping element fixed thereon because this clamping element may need to be torn off the bolt shaft after the locking ring is clamped thereon. Since the clamping element is situated outside the through-hole in the drawn-in position of the lockbolt, it may be advantageously utilized for securing the locking ring such that the lockbolt is prevented from unintentionally falling out by sliding the locking ring over the clamping element in the direction of the bolt shaft, wherein this may be easily realized due to the elastic properties of the clamping element. In clamping processes in which the locking ring is clamped on the bolt shaft, an installer has both hands available because it is no longer required to manually hold the locking ring on the tear-off shaft with one hand as it is the case with conventional riveting methods. In the lockbolt, this holding function is fulfilled by the clamping element. In comparison with conventional riveting methods, the inventive lockbolt therefore may allow a more ergonomic installation because the installer may be able to operate the clamping tool with both hands.

It should also be mentioned that the clamping element may have any arbitrary shape that is suitable for wedging the lockbolt in the through-hole by the wedge-type fastening of the tear-off shaft. According to one embodiment, the clamping element may be shaped, for example, in the form of an annular element that surrounds the tear-off shaft circumferentially. Alternatively, the clamping element may also be arranged on the tear-off shaft in a punctiform fashion and may have a drop shape, in one example.

The embodiments of the lockbolt also relate to the method and to the aircraft and vice-versa.

According to another embodiment, the objective thereof is attained with a method for producing a lockbolt connection between at least two component layers that have a through-hole for accommodating a lockbolt as described above. The inventive method may be carried out in several steps or processes, wherein this is mentioned in order to point out that one step may be carried out simultaneously with another step or conditionally on another step.

During the first process, a lockbolt is inserted into a through-hole of at least two component layers in such a way that the tear-off shaft of the lockbolt protrudes from the component layers to be joined. Due to this insertion of the tear-off shaft into the through-hole and therefore the simultaneous insertion of the clamping element of the tear-off shaft into the through-hole, the lockbolt is clamped in the through-hole by the clamping element and therefore is provisionally fastened. In this respect, the inventive method may not require the provisional fastening of the lockbolt in the through-hole by a separate provisional fastening stroke such that the aforementioned problems and disadvantages associated with such a provisional fastening stroke may be prevented.

After the lockbolt is fixed in the through-hole in this fashion, it may subsequently be drawn into the through-hole, for example, by utilizing a drawing tool such that the bolt head adjoins one of the component layers. This drawing of the lockbolt causes the tear-off shaft to be pulled out of the through-hole together with the clamping element arranged thereon such that a locking ring may be pushed on the tear-off shaft and over the clamping element and the locking ring is held on the tear-off shaft in a self-locking fashion by the clamping element. In contrast to known riveting methods, it may therefore be no longer required for an installer to manually hold the locking ring on the tear-off shaft with one hand in order to operate a clamping tool, for clamping the ring on the bolt shaft with the other hand. The inventive method in fact may allow an installer to use both hands for the operation of the clamping tool such that the installation may be carried out ergonomically.

Ultimately, the locking ring is clamped or headed on the bolt shaft and the tear-off shaft may be torn off the bolt shaft as it may be also the case in conventional riveting methods.

According to the preceding explanations, the lockbolt therefore may be clamped in position without requiring a separate provisional fastening stroke. This may allow prevention of damages to the lockbolt as well as annoying noise levels during the lockbolt installation.

In comparison with conventional riveting methods, the inventive method carried out by utilizing the lockbolt may be altogether quite cost-efficient, wherein a separate provisional fastening stroke as well as the manual holding of the locking ring on the tear-off shaft may be eliminated. This reduction of the process steps as well as the associated cost-efficiency manifests itself, in particular, in consideration of the thousands of lockbolts installed in a single aircraft. For example, the applicant installed numerous conventional lockbolts in its aircraft in the year 2004 by utilizing the above-described conventional riveting method. In a multitude of test riveting processes carried out by utilizing the inventive method, it was determined that the time required for inserting a lockbolt into a through-hole could be reduced by approximately 1.2 seconds and the time required for attaching a locking ring could be reduced by approximately I second such an overall cost optimization of 2.2 seconds per lockbolt was achieved. In one example, if 8,000,000 lockbolts are installed annually, the inventive method may reduce the working time by approximately 4900 hours such that cost savings of approximately [symbol] 200,000 may be realized at an average hourly wage of [symbol] 40.

### BRIEF DESCRIPTION OF THE DRAWINGS

FIG. 1 show examples of a conventional lockbolt riveting method with reference to Illustrations I-VI;

FIGS. 2-6 show embodiments of a method for producing a lockbolt connection with reference to snapshots of a cross section through a lockbolt connection.

Identical or similar elements are always identified by the same or corresponding reference characters in all figures. The illustrations in the figures are diagrammatic and not to scale.

### DETAILED DESCRIPTION OF EMBODIMENTS

The examples described and drawings rendered are illustrative and are not to be read as limiting the scope of the invention as it is defined by the appended claims.

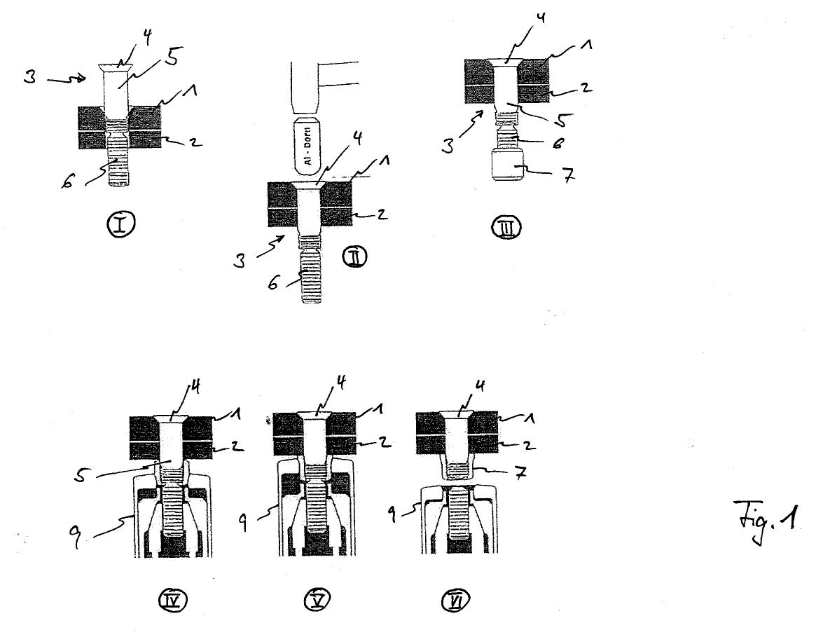

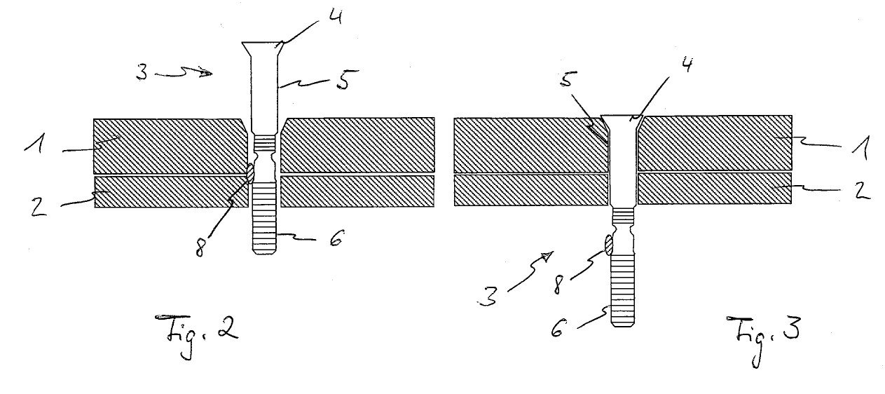

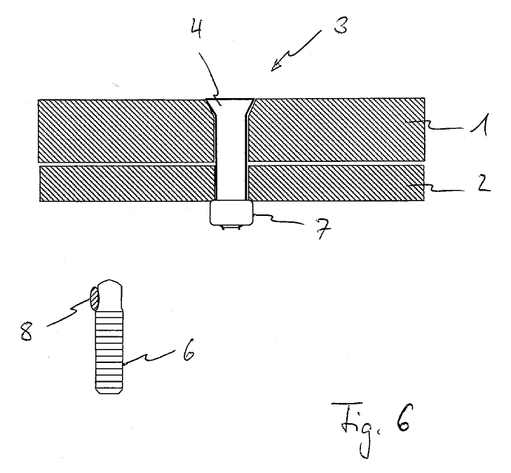

A conventional lockbolt 3 is initially described with reference to FIG. 1. The lockbolt 3 has a bolt head 4 as well as a bolt shaft 5 that conventionally protrudes from the bolt head 4. Although the bolt head 4 consists of a countersunk head in the special embodiments shown in FIGS. 2-6, the bolt head 4 may also be shaped in the form of a tallow-drop head, a square head, a hexagonal head or any other conceivable type of head. The lockbolt 3 furthermore has a tear-off shaft 6 that begins at the bolt head 4 in the form of an extension of the bolt shaft 5 and is connected to the bolt shaft 5 at a predetermined breaking point in the form of a material weakening. In one example, an elastic clamping element 8 is arranged on the tear-off shaft 6 and adapted for clamping a lockbolt 3 inserted into a through-hole therein as described below with reference to FIG. 2.

In FIG. 2, the bolt shaft 5 has a diameter D that is greater than a diameter d of the tear-off shaft 6. The diameter D is adapted to the diameter of the through-hole such that the bolt shaft 3 may be inserted therein in a precisely fitted fashion. In order to clamp the lockbolt 3 in the through-hole with the aid of the clamping element 8, the radial dimension of the clamping element 8 is chosen such that the diametrical dimension W of the clamping element 8 and the tear-off shaft 6 is greater than or equal to the diameter D of the bolt shaft 5.

In FIG. 2, a lockbolt 3 for producing a lockbolt connection between at least two component layers 1, 2 is inserted into the through-hole of the component layers 1, 2 such that the tear-off shaft 6 slightly protrudes from the component layers 1, 2 to be joined in order to ensure that the lockbolt 3 may subsequently be drawn into the through-hole with the aid for a drawing tool that takes hold of the tear-off shaft 6. FIG. 2 furthermore shows that the clamping element 8 is arranged on the tear-off shaft 6 in the vicinity of the predetermined breaking point between the bolt shaft 5 and the tear-off shaft 6 such that it may be ensured that the clamping element 8 is still situated in the through-hole in order to clamp the lockbolt 3 in the through-hole; the tear-off shaft 6 slightly protrudes from the component layers 1, 2 to be joined.

In the position illustrated in FIG. 2, the lockbolt is quasi provisionally fastened in the through-hole of both component layers 1, 2, wherein this is realized with the aforementioned provisional fastening stroke in conventional riveting methods. Consequently, this provisional fastening stroke may be no longer required because the lockbolt 3 may be simply pressed in under the influence of a slight force in the position illustrated in FIG. 2.

After the lockbolt 3 was clamped in the through-hole by the clamping element 8 during the insertion of the lockbolt 3, the lockbolt 3 may be completely drawn into the through-hole, for example, by utilizing a drawing tool such as tongs, wherein this causes the bolt head 4 to adjoin the upper component layer 1 or the countersinking hole arranged therein, respectively, as shown in FIG. 3.

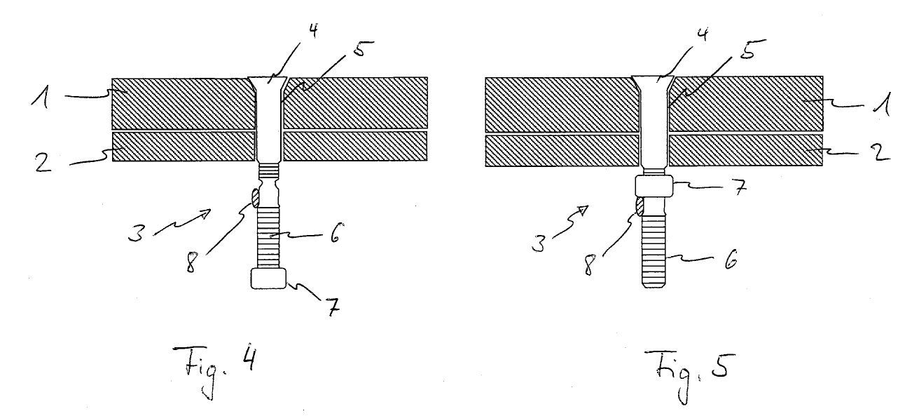

Subsequently as shown in FIG. 4, the process of pushing the locking ring 7 on the tear-off shaft from the bottom may begin. If the locking ring 7 is additionally displaced in the direction of the bolt shaft 5 and therefore over the clamping element 8 from its position shown in FIG. 4, the locking ring 7 is held on the tear-off shaft 6 by the clamping element 8 in a self-locking fashion. The clamping ring 8 therefore also may no longer slide off the lockbolt 3 during the overhead installation illustrated in FIGS. 2-6 such that the installer may have both hands available for actuating a clamping tool for clamping the locking ring 7 on the bolt shaft 5.

The final state of the lockbolt connection produced by utilizing the inventive lockbolt 3 is illustrated in FIG. 6, wherein the locking ring 7 was clamped on the bolt shaft 5 and the tear-off shaft 6 was torn off the bolt shaft 5. During the removal of the tear-off shaft 6, the clamping element 8 is removed from the lockbolt together therewith such that it advantageously does not remain in the lockbolt connection.

It should also be mentioned that “comprising” does not exclude any other elements or steps, and that “a” or “an” does not exclude a plurality. It should furthermore be noted that characteristics or steps described with reference to one of the above embodiments can also be used in combination with other characteristics or steps of other above-described embodiments. The reference symbols in the claims should not be understood in a restrictive sense.

### LIST OF REFERENCE SYMBOLS

1 First component layer

2 Second component layer

3 Lockbolt

4 Bolt head

5 Bolt shaft

6 Tear-off shaft

7 Locking ring

8 Clamping element

9 Clamping tool

What is claimed is:

1. A lockbolt for joining at least two component layers which have a through-hole for accommodating the lockbolt, the lockbolt comprising:
a bolt head;
a bolt shaft that protrudes from the bolt head; and
a tear-off shaft extending from the bolt head in the form of an extension of the bolt shaft and connected to the bolt shaft at a predetermined breaking point, the tear-off shaft including an elastic clamping element for temporarily fixing the lockbolt in the through-hole.

2. The lockbolt of claim 1,
wherein the clamping element is adapted for clamping a lockbolt inserted into a through-hole.

3. The lockbolt of claim 1,
wherein the bolt shaft has a first diameter and the tear-off shaft has a second diameter in a region of the clamping element, the second diameter being smaller than the first diameter, and a combined thickness of the clamping element and a portion of the tear-off shaft having the second diameter is greater than or equal to the first diameter of the bolt shaft.

4. The lockbolt of claim 1,
wherein the clamping element is arranged on the tear-off shaft in such a way that the tear-off shaft protrudes from the component layers to be joined in a temporarily fixed position of the lockbolt.

5. The lockbolt of claim 1,
wherein the clamping element is shaped in the form of a ring that surrounds the tear-off shaft circumferentially.

6. The lockbolt of claim 1,
wherein the clamping element is arranged on the tear-off shaft in a punctiform fashion.

7. A method for producing a lockbolt connection between at least two component layers which have a through-hole for accommodating a lockbolt of claim 1, comprising steps of
inserting the lockbolt into the through-hole such that the tear-off shaft protrudes from the component layers to be joined;
clamping the lockbolt in the through-hole by the clamping element;
drawing the lockbolt into the through-hole such that the bolt head adjoins one of the component layers;
sliding a locking ring on the tear-off shaft and over the clamping element such that the locking ring is held on the tear-off shaft in a self-locking fashion by the clamping element;
clamping the locking ring on the bolt shaft; and
tearing the tear-off shaft off the bolt shaft.

8. The method of claim 7, wherein the step of clamping the lockbolt does not include a provisional fastening stroke.

9. An aircraft in which at least two component layers of a structural component are joined with at least one lockbolt of claim 1.
